(19) United States
(12) Patent Application Publication
(10) Pub. No.: US 2025/0235389 A1
(43) Pub. Date: Jul. 24, 2025

(54) SOOTHING NOISE DEVICE FOR A PACIFIER

(71) Applicant: Michael D. Muniz, Pleasant Grove, UT (US)

(72) Inventor: Michael D. Muniz, Pleasant Grove, UT (US)

(21) Appl. No.: 18/419,402

(22) Filed: Jan. 22, 2024

(51) Int. Cl. A61J 17/00

(52) U.S. Cl. CPC A61J 17/1011; A61J 17/001

(57) ABSTRACT

A soothing noise device for a pacifier includes a body couplable to a pacifier. The body may include a recess in the body. The device includes a circuit board disposed at least partially inside the recess. The device includes a speaker connected to the circuit board. The device includes a sound emission aperture disposed over the speaker. The sound emission aperture is adapted to allow sound from the speaker to be emitted through the sound emission aperture. The soothing noise device can emit soothing noises while an infant or young child uses the pacifier. A soothing noise device may be disposable inside a stuffed toy. The sounds emitted from the device may be at a volume that is safe for the ears of infants or young children close to the device.

### TECHNICAL FIELD

The instant specification generally relates to devices that emit sound. More specifically, the instant specification relates to a soothing noise device for infants and young children.

### BACKGROUND

Certain sounds have been found to help infants and young children fall asleep, stay asleep, and otherwise sooth infants and young children. Such sounds often include a white noise. Different machines exist that emit soothing sounds.

### SUMMARY

Disclosed herein is a soothing noise device. The device can include a body couplable to a pacifier. The body may include a recess. The device may include a circuit board disposed at least partially inside the recess. The device may include a speaker connected to the circuit board. The device may include a sound emission aperture disposed over the speaker. The sound emission aperture may be adapted to allow sound from the speaker to be emitted through the sound emission aperture. The device may emit soothing sounds at a volume such that the device may be close to an infant's or young child's ears without damaging the infant's or child's ears.

Another aspect of the disclosure includes a soothing noise assembly. The assembly may include a pacifier. The pacifier may include an artificial nipple and a shield disposed on an end of the artificial nipple. The assembly may include a soothing noise device. The device can include a body couplable to a pacifier. The body may include a recess. The device may include a circuit board disposed at least partially inside the recess. The device may include a speaker connected to the circuit board. The device may include a sound emission aperture disposed over the speaker. The sound emission aperture may be adapted to allow sound from the speaker to be emitted through the sound emission aperture. The device may emit soothing sounds at a volume such that the device may be close to an infant's or young child's ears without damaging the infant's or child's ears.

Another aspect of the disclosure includes another soothing noise device. The device may include a body that includes an outer shell and an enclosure surrounded by the outer shell. The device may include a circuit board disposed at least partially in the enclosure. The device may include a speaker connected to the circuit board. The device may include a sound emission aperture disposed over the speaker, wherein the sound emission aperture is adapted to allow sound from the speaker to be emitted through the sound emission aperture. The device may be adapted for disposal in a stuffed toy. The device may emit soothing sounds at a volume such that the device may be close to an infant's or young child's ears without damaging the infant's or child's ears.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A is a perspective view of an example embodiment of a soothing noise device for a pacifier by which selected aspects of the present disclosure may be implemented, in accordance with various embodiments.

FIG. 1B is an exploded perspective view of the example embodiment of the soothing noise device for a pacifier of FIG. 1A, in accordance with various embodiments.

FIG. 2 is a schematic block diagram illustrating an example embodiment of a circuit board for use in a soothing noise device for a pacifier by which selected aspects of the present disclosure may be implemented, in accordance with various embodiments.

FIG. 3 is a cutaway side view illustrating an example embodiment of a soothing noise device for a pacifier selectably coupled to a pacifier, in accordance with various embodiments.

FIG. 4A is a perspective view of an example embodiment of a soothing noise assembly by which selected aspects of the present disclosure may be implemented, in accordance with various embodiments.

FIG. 4B is an exploded perspective view of the example embodiment of the soothing noise assembly of FIG. 4A, in accordance with various embodiments.

FIG. 5A is a perspective view of an example embodiment of a soothing noise device by which selected aspects of the present disclosure may be implemented, in accordance with various embodiments.

FIG. 5B is an exploded perspective view of the example embodiment of the soothing noise device of FIG. 5A, in accordance with various embodiments.

FIG. 6 is a front view of an example embodiment of the soothing noise device of FIGS. 5A-B disposed inside a stuffed toy, in accordance with various embodiments.

### DETAILED DESCRIPTION

Devices that emit soothing sounds can be used to sooth infants and young children. However, sometimes there are concerns that the volume levels of one of these devices may be harmful to an infant's or young child's ears if the device were to be close to the infant or young child. Furthermore, such devices are often relatively large, must be plugged into a wall socket to supply power to the device, and placed out of reach of the infant or young child because it may not be safe for the device to be within reach of the infant or child. Additionally, such devices are often not portable, making them unusable outside of the infant's or young child's room, such as in a vehicle or while the child is with a parent running errands.

Aspects and implementations of the present disclosure address the above deficiencies, among others, by providing a soothing noise device that is couplable or otherwise disposed on a pacifier or in a stuffed toy. The device may include a body that can contain a circuit board, a speaker connected to the circuit board, or a cover disposed over the speaker. The cover can include a sound emission aperture adapted to allow sound from the speaker to be emitted through the sound emission aperture. The speaker may emit a variety of soothing noises provided by the circuit board. The speaker may emit the soothing noises at a volume level that is safe for an infant's or young child's ears even when the device is close to the infant's or young child's ears. The soothing noise device is mobile and may receive power from a battery disposed in the device.

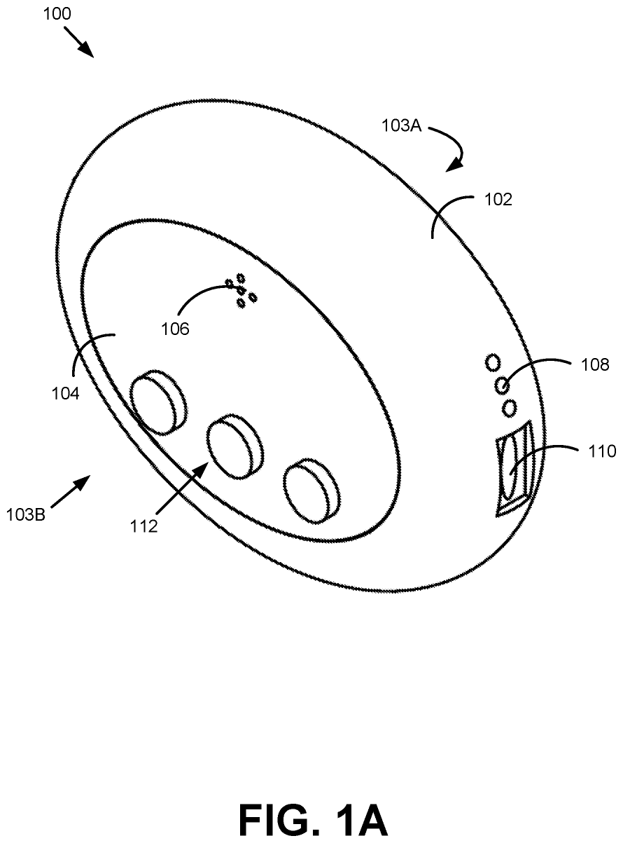

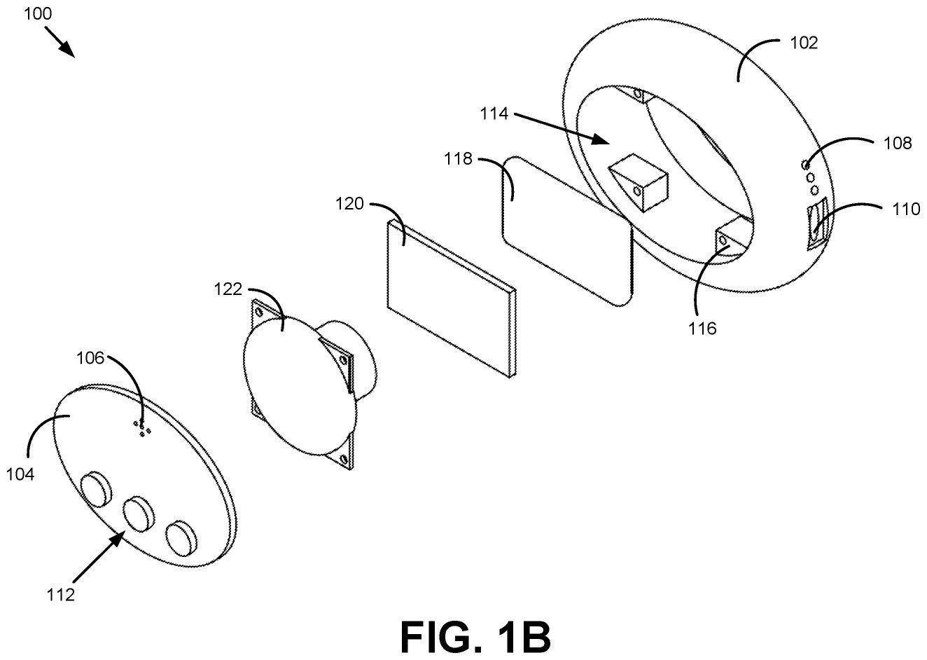

FIG. 1A depicts an example embodiment of a soothing noise device 100 for a pacifier. The device 100 may include a body 102. The device 100 may include a cover 104. The device 100 may include one or more sound emission apertures 106. The device 100 may include one or more light indicators 108. The device 100 may include a port 110. The device 100 may include one or more adjustment assemblies 112.

In some implementations, the body 102 may include a housing for one or more other components of the device 100. The body 102 may securely encase one or more components of the device 100. The body 102 may include a plastic or some other rigid material. The body 102 may include a material that is child safe. The body 102 may include an ergonomic shape that may be easy for an infant or young child to hold or manipulate. The body 102 may include a round disk shape, as shown in FIG. 1A. The body 102 may include other shapes. The body 102 may be couplable to a pacifier. In some implementations, the body 102 may include a first side 103A adapted to couple to a pacifier. The body 102 may include a second side 103B that is disposed opposite the first side 103A.

In some implementations, the second side 103B of the body 102 may include a recess in the body 102. The recess in the body 102 may hold one or more components of the device 100, as discussed below.

In one implementation, the cover 104 may include a portion of material that is selectably disposable on the body 102. The cover 104 may be selectably removable from the body 102 in order to temporarily allow access to components of the device 100 that are disposed within the body 102. The cover 104 may snap to the body 102, screw into the body (e.g., using a threading disposed on the cover 104 and a portion of the body 102), or may selectably couple to the body in some other way.

In one or more implementations, the one or more sound emission apertures 106 may be adapted to allow sound from a speaker to be emitted through the one or more sound emission apertures. The one or more sound emission apertures 106 may include holes or other openings. In some implementations, as shown in FIG. 1A, the one or more sound emission apertures 106 may be disposed in the cover 104. The one or more sound emission apertures 106 may be disposed on the device 100 to deliver sound at a consistent volume without distortion. In some implementations, the one or more sound emission apertures may be disposed in the body 102 or may be disposed in both the cover 104 and the body 102. In some implementations, the one or more sound emission apertures 106 may include a thin fabric disposed inside the sound emission apertures 106 that may allow sound to be emitted through the sound emission apertures 106 but may prevent debris from entering the body 102 through the sound emission apertures 106.

In some implementations, the one or more light indicators 108 may connect to a circuit board. The one or more light indicators 108 may include a light assembly configured to emit light to indicate information about the device 100. The one or more light indicators 108 may include a light-emitting diode (LED) or some other lighting device. The one or more light indicators 108 may indicate whether the device 100 is on, a battery level of the device 100, whether the device 100 is currently charging, whether the device 100 is currently emitting sound, or some other state or configuration of the device 100. In one implementation, the one or more light indicators 108 may be disposed on a surface of the body 102. In some implementations, the one or more light indicators 108 may be disposed on the cover 104 or on a combination of the body 102 and the cover 104. As an example, a first light indicator 108 may include a light that illuminates when the device 100 is on and does not illuminate when the device is off. A second light indicator 108 may illuminate when the device 100 is charging and may not illuminate when the device is not charging. A third light indicator 108 may illuminate at different colors in response to a battery level of the device (e.g., green when the battery is above 50% charge, yellow when the battery is at 20% to 50% charge, and red when the battery is below 20% charge). In some implementations, one or more light indicators 108 may indicate the battery level of the device 100 by using a number of illuminated lights (e.g., three lights when the battery is above 50% charge, two lights when the battery is at 20% to 50% charge, and one light when the battery is below 20% charge).

In some implementations, the port 110 may include a power charging port, a data connection port, or some other type of port. The port 110 may provide an interface between the device 100 and some other device or a power source. The port 110 may be connectable to a cable. The cable may supply power to the device 100 to charge a battery of the device 100. The cable may transmit data to the device 100 and transmit data from the device 100. In one implementation, the port 110 may include a Universal Serial Bus (USB) port (e.g., a USB-C port, a USB-Mini B port, a USB-Micro B port, or some other type of USB port) or some other type of charging or data connection port. In some embodiments, the port 110 may include a port cover. The port cover may include a piece of material that may selectable cover the port 110 to prevent debris from entering the port 110. The port cover may include a material similar to the body 102 or the cover 104 or may include a different material.

In one implementation, the one or more adjustment assemblies 112 may include a mechanism that a user may interact with to activate or deactivate certain functionality of the device 100. A portion of an adjustment assembly 112 may connect to a circuit board of the device 100 to cause the activation/deactivation of certain device functionality. An adjustment assembly 112 may include a button, a switch, a scroll wheel, a knob, or some other type of mechanism.

In one implementation, the one or more adjustment assemblies 112 may include a power button assembly. The power button assembly may activate or deactivate the device 100 (i.e., turn the device 100 on or off). In some embodiments, responsive to the device 100 being activated, the device 100 may automatically emit sound. In other embodiments, responsive to the device 100 being activated, the device 100 may not immediately emit sound, and the user interacting with a sound adjustment assembly (discussed below) may cause the device 100 to emit sound. Responsive to the device 100 being deactivated, the device 100 may cease to emit sound.

In some implementations, the one or more adjustment assemblies 112 may include a volume adjustment assembly. The volume adjustment assembly may adjust the volume of the device 100. The volume adjustment assembly may maintain a volume level of the device 100 within a safe and comfortable range for an infant or young child while the device 100 is on. As an example, the volume adjustment assembly may include a scroll wheel. Rotating the scroll wheel in one direction may increase the volume, and rotating the scroll wheel in the opposite direction may decrease the volume. In another example, the volume adjustment assembly may include a first button that increases the volume and a second button that decreases the volume.

In some implementations, the one or more adjustment assemblies 112 may include a sound adjustment assembly. As discussed further below, the device 100 may be configured to emit multiple different sounds. The sound adjustment assembly may change the sound emitted from a speaker of the device 100. As an example, the one or more sound adjustment assemblies may include a button. Pressing the button may change the sound emitted by the device 100, and pressing the button again may change the emitted sound again. Pressing the button may cycle through multiple different sounds. In another example, the one or more sound adjustment assemblies may include a first button and a second button. Pressing the first button may change the sound emitted by the device 100, and pressing the second button may change the sound back to the previous sound. In another example, the one or more sound adjustment assemblies may include multiple button assemblies. Each button assembly may correspond to a predetermined sound, and pressing a button assembly may activate that button's predetermined sound. In another example, the one or more sound adjustment assemblies may include a scroll wheel. Rotating the scroll wheel in one direction may cycle through different sounds emitted by the device 100, and rotating the scroll wheel in the opposite direction may cycle through the different sounds in a reverse order.

FIG. 1B depicts an example embodiment of the soothing noise device 100 of the FIG. 1A in an exploded view. The view of FIG. 1B depicts components not seen in FIG. 1A. In some embodiments, the device 100 may include a recess 114 in the body 102, one or more speaker mountings 116, a battery 118, a circuit board 120, or a speaker 122.

The recess 114 may include an area disposed within the body 102 that is enclosed by the body 102 and, in some implementations, the cover 104. The recess 114 may hold the battery 118, the circuit board 120, or the speaker 122.

In some implementations, the one or more speaker mountings 116 may include a mechanism for disposing the speaker 122 or other components in the recess 114. The one or more speaker mountings 116 may include micro-screws or other fasteners. The one or more speaker mountings 116 may provide structural integrity to the speaker 122 or other components of the device 100 and prevent rattling or sound distortion by the speaker 122 or other components to provide a clear output sound.

In one implementation, the battery 118 may include a battery disposed in the recess 114 and may be connected to the circuit board 120. The battery 118 may supply power to various components of the device, such as the circuit board 120 or the speaker 122. The battery 118 may include a rechargeable battery. The battery 118 may include a lithium-ion battery.

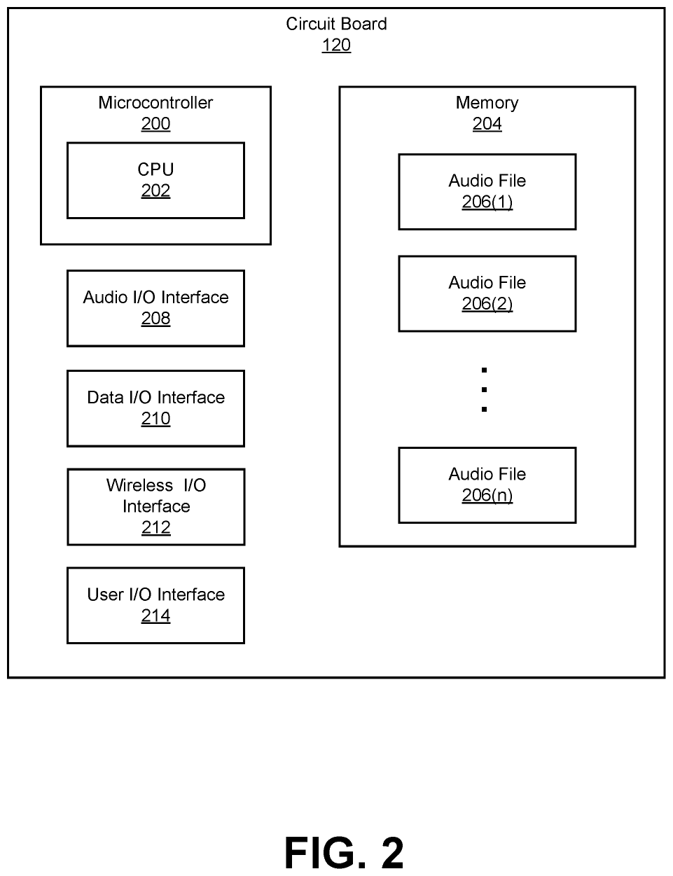

In some implementations, the circuit board 120 may be at least partially disposed inside the recess 114. The circuit board 120 may include a printed circuit board assembly (PCBA). FIG. 2 depicts an example schematic diagram of the circuit board 120. The circuit board 120 may include a microcontroller 200. The microcontroller 200 may include a self-contained computer on a single integrated circuit (IC) that is designed to perform specific tasks. The microcontroller 200 may include a central processing unit (CPU) 202. The circuit board 120 may include a memory 204, which may include one or more audio files 206(1)-(n). The circuit board 120 may include one or more input/output (I/O) interfaces. The one or more I/O interfaces may include an audio I/O interface 208, a data I/O interface 210, a wireless I/O interface 212, or a user I/O interface 214. The microcontroller 200 or the memory 204 may include one or more programs or other software. The one or more programs may execute on the microcontroller 200. In some implementations, the microcontroller 200 may include firmware, embedded programs, or other data.

The CPU 202 may include a central processing unit (CPU), a processing core, or the like. More particularly, the CPU 202 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The CPU 202 can also be one or more special-purpose processing devices such as an ASIC, a field programmable gate array (FPGA), a digital signal processor (DSP), or the like. The CPU 202 may be configured to execute instructions (e.g., for performing one or more operations described herein).

The memory 204 may include volatile memory or non-volatile memory. The memory 204 may include read-only memory (ROM), flash memory, dynamic random-access memory (DRAM) such as synchronous DRAM (SDRAM), double data rate (DDR SDRAM), or DRAM (RDRAM), static random-access memory (SRAM), or some other type of memory. The memory 204 may store the one or more programs that execute by way of the CPU 202.

The one or more audio files 206(1)-(n) may include audio files used to emit soothing sounds through the speaker 122. In some implementations, the one or more audio files 206(1)-(n) may each include a different soothing noise. A soothing noise may include a white noise, a hum at a predetermined range of frequencies, music, or some other type of audio.

The CPU 202 may provide an audio file 206 to a decoder to decode the audio file 206 into a stream of samples. The decoder may extract sound information from the samples (e.g., amplitude or frequency information) and convert the information into analog signals. The decoder may provide the analog signals to the speaker 122 through the audio I/O interface 208. The audio I/O interface 208 may connect the speaker 122 to the circuit board 120, and the CPU 202 may provide analog signals to the audio I/O interface to provide to the speaker 122.

In some embodiments, the CPU 202 may play an audio file 206 on a loop (i.e., the CPU 202 may play the same audio file 206 again in response to reaching the end of the audio file 206). The CPU 202 may play the one or more audio files 206(1)-(n) one after another. The CPU 202 may change which audio file 206 it is playing in response to user interaction with an audio adjustment assembly, discussed above.

In one implementation, the data I/O interface 210 may include an interface between the circuit board 120 and the port 110. The port 110 may receive data via a cable, and the data I/O interface 210 may receive the data from the port 110 and provide the data to the CPU 202. The CPU 202 may process the data and store the processed data in the memory 204. In some implementations, the data may include an audio file 206. A user of the device 100 may provide an audio file 206 to the device 100, and the CPU 202 may store the audio file 206 in the memory 204 as one of the one or more audio files 206(1)-(n). The memory 204 may include a file system, and a user may use the file system to add audio files 206 to, or remove audio files 206 from, the memory 204. The user may control other configurations of the device 100 using the data I/O interface 210.

In some implementations, the wireless I/O interface 212 may be in data communication with a mobile device. The mobile device may include a wireless-capable device of the user of the device 100. The wireless I/O interface 212 may be configured to receive wireless signals from the mobile device to perform one or more operations on the circuit board 120. The user's mobile device may include a smartphone, a tablet, a laptop computer, or some other wireless-capable device. The wireless I/O interface 212 may include a Bluetooth interface, a Wi-Fi interface, or an interface for some other wireless protocol. The wireless I/O interface may receive a wireless signal from the mobile device, process the signal to obtain data (e.g., extract data from a packet contained in the wireless signal), and send the data to a component of the circuit board (e.g., the microcontroller 200 or the memory 204) to perform one or more operations on the circuit board 120.

In one implementation, the user's mobile device may include a mobile application or some other software that the user may use to interact with the device 100 using the wireless I/O interface 212. The user may use the mobile application to adjust a volume of the device 100. The user may use the mobile application to select an audio file 206 from the one or more audio files 206(1)-(n) for the device 100 to play, upload an audio file 206 to the circuit board 120 for storage in the memory 204, or delete an audio file from the memory 204. The user may use the mobile application to enable a configuration of the device 100. A configuration of the device 100 may include a setting that limits a maximum volume of the speaker 122 or a timer that controls when the device 100 automatically deactivates (e.g., at a certain time of the day or a certain amount of time after the device 100 has received no input from the mobile application or the one or more adjustment assemblies 112).

In some implementations, the wireless I/O interface 212 may send wireless signals to the user's mobile device. The user's mobile device's wireless I/O interface may receive the signal, process the signal to obtain data, and send the data to the mobile application. The mobile application may display, on a user interface (UI) of the mobile application, information about the device 100 based on the received data in the signal. The information may include the name of a currently playing audio file 206, a timestamp indicating where in the playback of the audio file 206 the circuit board 120 is, a current battery level of the device 100, how long the device 100 has been activated, a software version number, or other information.

The user I/O interface 214 may include an interface between the one or more light indicators 108 and the circuit board 120, an interface between the one or more adjustment assemblies 112 and the circuit board 120, or an interface between other components of the device 100 and the circuit board 120. The one or more light indicators 108 may receive one or more signals from the CPU 202 through the user I/O interface 214, which may determine which light indicator(s) 108 should illuminate. The one or more adjustment assemblies 112 may send one or more signals to the CPU 202 through the user I/O interface 214, and the CPU 202 may perform certain functionality based on the received signals (e.g., adjust the volume of the speaker 122, play a different audio file 206, etc.).

In some embodiments, the microcontroller 200 may include the memory 204 as onboard memory. In one or more embodiments, the microcontroller 200 may include one or more of the audio I/O interface 208, the data I/O interface 210, or the user I/O interface 214.

Returning to FIG. 1B, the speaker 122 may be connected to the circuit board 120 and may include an audio speaker adapted to emit sounds. The speaker 122 may receive analog signals from the circuit board 120 and may emit sounds based on those analog signals. The speaker 122 may be disposed in the device 100 such that the speaker faces toward the one or more sound emission apertures 106.

In some implementations, the speaker 122 may emit sounds at or below a threshold volume. In some embodiments, one or more components of the speaker 122 may limit the volume of the speaker 122 to below the threshold volume. For example, the hardware of the speaker 122 may prevent the speaker 122 from emitting sounds above the threshold volume (i.e., the components of the speaker 122 may not physically be able to generate sounds above the threshold volume). In certain embodiments, the circuit board 120 may limit the volume of the speaker 122 to below a threshold volume. For example, the software or firmware executed by the microcontroller 200 may prevent the audio I/O interface 208 from outputting analog signals that would result in the speaker 122 emitting sounds above the threshold volume. The software executed by the microcontroller 200 may track a current volume level of the sounds emitted by the speaker 122, and in response to receiving user input attempting to increase the volume level (e.g., input received by the user I/O interface 214 from a volume adjustment assembly), the microcontroller 200 may ignore such input or otherwise not accept such input.

The threshold volume may be a volume that is safe for an infant's or young child's ears even in close proximity. In some implementations, the threshold volume may be substantially 50 decibels (dB). In one or more implementations, the threshold volume may be substantially 40 dB, 30 dB, or lower. In one implementation, the threshold volume may be substantially 60 dB or higher. The threshold volume being, substantially, a specified volume may include the threshold volume being within 5 dB of that specified volume.

In some implementations, the speaker 122 may emit sounds at a certain volume level for a temporary period of time but may slowly decrease the volume to a volume level that may be safer for long periods of listening. The rate of volume level decrease may be unnoticeable. For example, the speaker 122 be start at a volume level of 50 dB and may emit sounds at this level for 10 minutes. After the 10 minutes, the speaker's 122 volume may automatically decrease by 1 dB every minute for 20 minutes until the volume reaches 30 dB. The speaker 122 may then remain at 30 dB until the user adjusts the volume.

In some embodiments, the device 100 may include a video display unit (not pictured in FIG. 1A or 1B). The video display unit may include a liquid crystal display (LCD) or some other type of video display. The video display unit may be in signal communication with the circuit board 120 using the user I/O interface 214. The video display unit may display information associated with the operation of the device 100. For example, the video display unit may display a status of the device 100 (e.g., whether the device is on, currently playing a sound, a current battery level, etc.). The video display unit may display a menu with one or more options a user can select. For example, a menu may include a list of audio files 206(1)-(n), a list of audio options, or other menu items. The video display unit may display information about an audio file 206 currently being played over the speaker 122 (e.g., the name of the audio file 206, the length of the audio file 206, etc.).

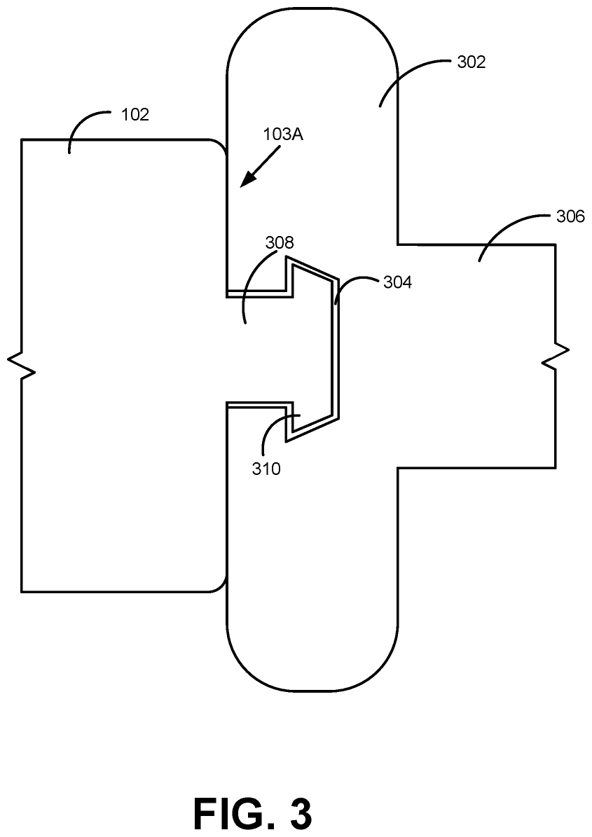

As discussed above, in some implementations, the device 100 may be couplable to a pacifier. The pacifier may selectably couple to the first side 103A of the body 102 of the device 100. FIG. 3 depicts one example embodiment of a pacifier coupled to the first side 103A of the body 102. As seen in FIG. 3, a pacifier 302 may include a recess 304. The recess 304 may be disposed on a side of the pacifier 302 that is opposite an artificial nipple 306. The recess 304 may be sized and shaped to receive a protrusion 308 that extends from the body 102 on the first side 103A of the body 102. The protrusion 308 may include a flange 310 that may hold the protrusion 308 inside the recess 304 of the pacifier 302. The protrusion 308 of the body 102 or the recess 304 of the pacifier 302 may be sized and shaped such that an adult may be able to pull on the body 102 or the pacifier 302 to remove the protrusion 308 from the recess 304 of the pacifier 302 and decouple the body 102 from the pacifier 302, but an infant or young child may not have sufficient strength to decouple the body 102 from the pacifier 302.

In another embodiment, the first side 103A of the body 102 of the device 100 may include a recess (which may be different than the recess 114 discussed above), and a portion of the pacifier 302 may include a protrusion that fits into the recess of the first side 103A of the body 102. The protrusion may include a flange that may hold the protrusion of the pacifier 302 inside the recess of the first side 103A. The protrusion of the pacifier 302 or the recess of the first side 103A of the body 102 may be sized and shaped such that an adult may be able to pull on the body 102 or the pacifier 302 to remove the protrusion of the pacifier 302 from the recess of the body 102 and decouple the body 102 from the pacifier 302, but an infant or young child may not have sufficient strength to decouple the body 102 from the pacifier 302.

In another embodiment, the recess 304 of the pacifier 302 may be sized and shaped to receive at least a portion of the body 102 (e.g., at least a portion of the first side 103A of the body 102). The body 102 may, at least in part, be sized and shaped to fit inside the recess 304 of the pacifier 302. In one embodiment, the first side 103A of the body 102 may couple to the pacifier 302 by an adhesive. In other embodiments, the first side 103A of the body 102 may couple to the pacifier 302 using other mechanisms.

In another embodiment, the first side 103A of the body 102 and the pacifier 302 may selectably couple using one or more interlocking grooves. The interlocking grooves may include slots that allow the first side 103A to slide into the interlocking grooves, and the user may then rotate the body 102 or the pacifier 302 to lock the body 102 and the pacifier 302 together. In another embodiment, the first side 103A and the pacifier 302 may include complementary threadings. The user may selectably couple the body 102 and the pacifier 302 by aligning the threadings and screwing the body 102 and the pacifier 302 together.

In another embodiment, the first side 103A of the body 102 and the pacifier 302 may selectably couple using magnetic attachment. The first side 103A may include a magnet disposed on an outside surface of the body 102 so that the magnet does not interfere with circuitry of the device 100. The pacifier 302 may include a magnet of an opposite polarity.

In some embodiments, the soothing noise device 100 may weigh 0.1 pounds or 45 grams. In certain embodiments, the device 100 may weigh less than 0.1 pounds or 45 grams. The weight of the device 100 may allow the device 100 to couple to a pacifier 302 such that the pacifier 302 and the device 100 are not too heavy for the infant or young child using the pacifier 302. The pacifier 302 and the device 100 may not cause the head of an infant or young child to significantly droop or otherwise be strained while the infant or young child uses the pacifier 302.

The soothing noise device 100 may allow a user to selectably couple the device 100 to a pacifier 302 or otherwise dispose the device 100 on the pacifier 302. The soothing noise device 100, in close proximity to an infant or young child using the pacifier, may sooth the infant or young child. The device 100 may be in close proximity to the infant's or young child's ears, but the sound emanating from the device 100 may not damage the infant's or young child's ears.

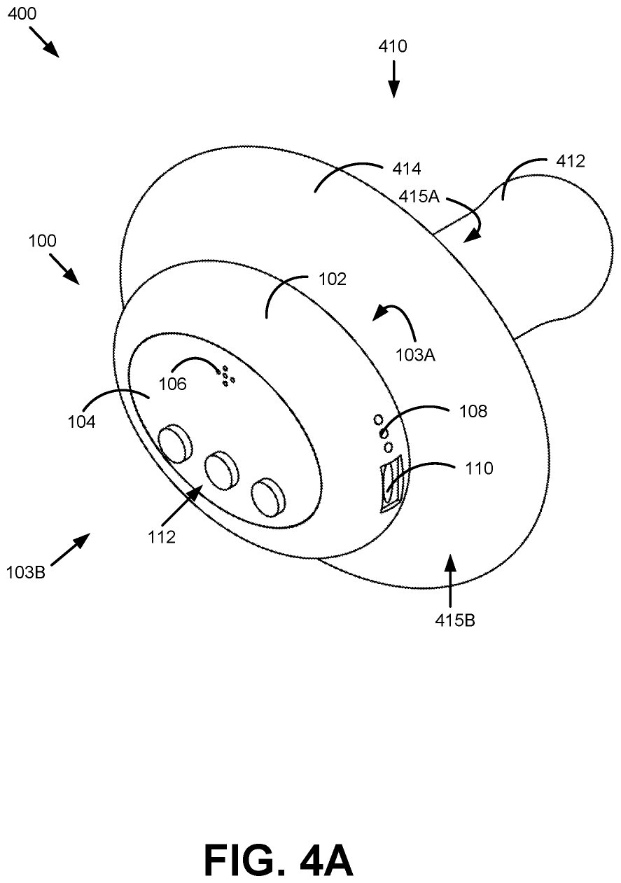

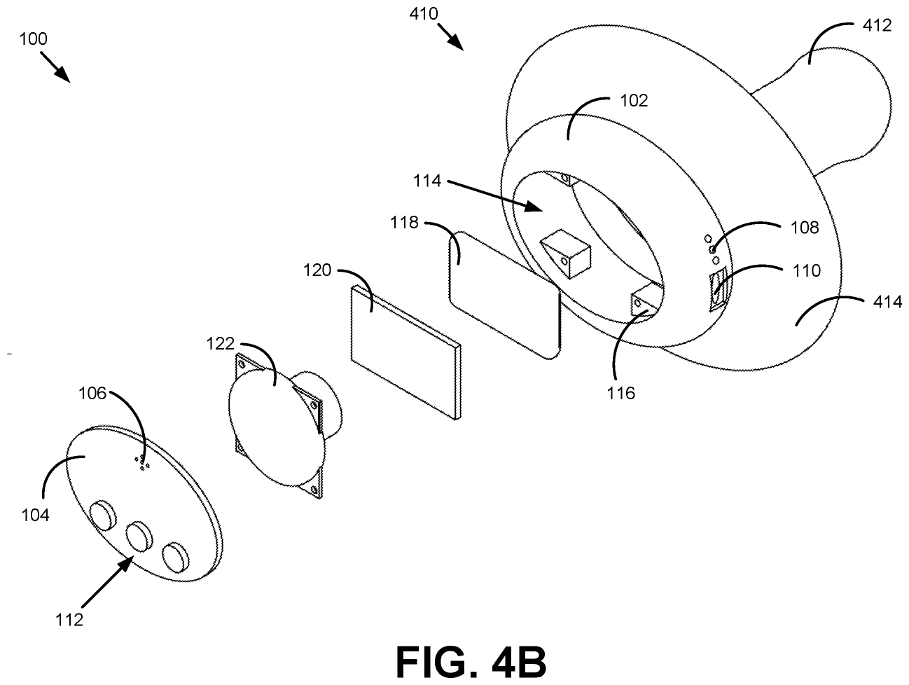

FIG. 4A and FIG. 4B depict a soothing noise assembly 400. The soothing noise assembly 400 may include a soothing noise device 100. The soothing noise device 100 may include one or more components described above regarding the soothing noise device 100 of FIGS. 1A-B and, thus, a description of these components will not be repeated here. Components depicted in FIGS. 4A-B with the same element numbers as components depicted in FIGS. 1A-B may include similar structures and functionality.

In one implementation, the soothing noise assembly 400 may include a pacifier 410. The pacifier 410 may include an artificial nipple 412. The pacifier 410 may include a shield 414. The shield 414 may be disposed on an end of the artificial nipple 412.

In some implementations, the artificial nipple 412 may include an elongated piece of material adapted, shaped, or sized for insertion into the mouth of an infant or a young child. The artificial nipple 412 may include a silicone. The silicone material may include medical-grade silicone that may provide biocompatibility and may be hypoallergenic. The artificial nipple 412 may include a soft texture adaptable to be gentle on an infant's or young child's mouth. The artificial nipple 412 may be odorless or taste-neutral.

The shield 414 may include a piece of material shaped and sized to prevent over-insertion of the artificial nipple 412 in the mount of an infant or young child. The shield 414 may include a first side 415A disposed toward the artificial nipple 412. In some cases, the artificial nipple may protrude from the first side 415A of the shield 414. The shield 414 may include a second side 415B that is disposed opposite the first side 415A. A body 102 of the soothing noise device 100 may be disposed on the second side 415B of the shield 414.

In some implementations, the soothing noise device 100 may be disposed on the shield 414. In one embodiment, the device 100 may be integral with the shield 414. In some embodiments, the device 100 may be disposed on the shield 414 in a manner that is similar to the device 100 and the pacifier 302, as discussed above. For example, in some embodiments, the device 100 may include a protrusion disposed on the first side 103A of the body 102, and the protrusion may be shaped and sized for insertion into a recess on the second side 415B of the shield 414. The protrusion may include a flange. In other embodiments, the shield 414 may include a protrusion disposed on the second side 415B of the shield 414. The protrusion may be shaped and sized for insertion into a recess (which may be different than the recess 114) of the first side 103A of the body 102 of the device 100. In some embodiments, the body 102 of the device 100 may, at least partially, be inserted into a recess on the second side 415B of the shield 414. In some embodiments, an adhesive may dispose the first side 103A of the body 102 of the device 100 on the second side 415B of the shield 414.

The soothing noise assembly 400, in close proximity to an infant or young child using the pacifier, may sooth the infant or young child while the infant or young child uses the pacifier 410. The assembly 400 may be in close proximity to the infant's or young child's ears, but the sound emanating from the assembly 400 may not damage the infant's or young child's ears.

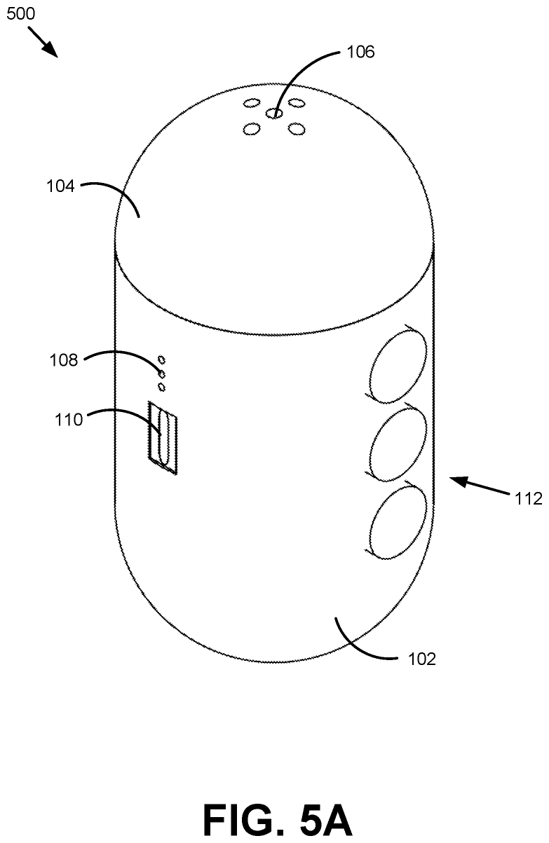

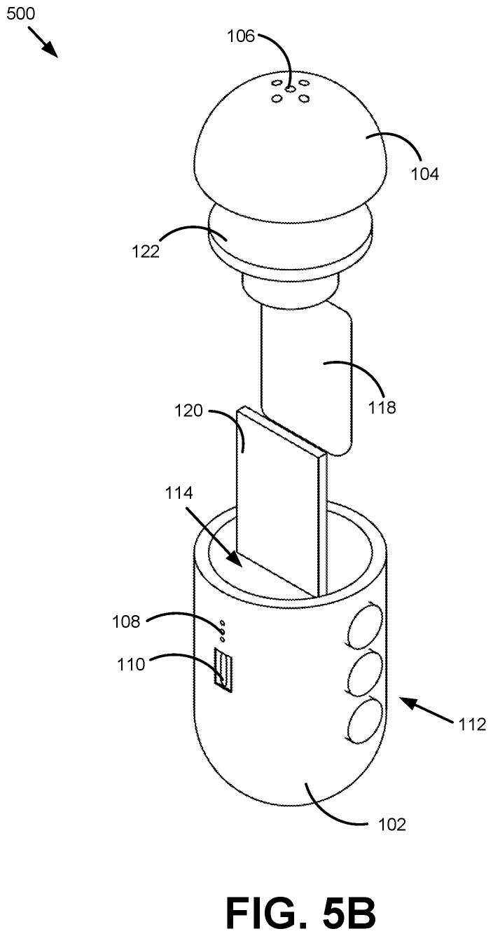

FIG. 5A and FIG. 5B depict another embodiment of a soothing noise device 500. The soothing noise device 500 may include one or more components described above regarding the soothing noise device 100 of FIGS. 1A-B and, thus, a description of these components will not be repeated here. Components depicted in in FIGS. 5A-B with the same element numbers as components depicted in FIGS. 1A-B may include similar structures and functionality.

In some implementations, the soothing noise device 500 may include a body 102 that includes an outer shell and an enclosure surrounded by the outer shell. In some implementations, the enclosure may include the recess 114. The body 102 may be adapted for disposal in a stuffed toy. As an example, a stuffed toy may include an opening that may allow a user to access an inner portion of the stuffed toy. The user may activate the soothing noise device 500 and dispose the soothing noise device 500 inside the stuffed toy via the stuffed toy's opening. In this manner, an infant or young child may interact with the stuffed toy and be soothed by the soothing noise device 500.

In one or more implementations, each of the body 102 and the cover 104 of the soothing noise device 500 may include a threading. The threading of each of the body 102 and the cover 104 may be formed such that the two threadings are adapted to screw together. The body 102 and the cover 104 may couple together by the threadings. The threadings may allow a user to selectively dispose the cover 104 on the body 102 so that the user can remove the cover 104 and access the enclosure of the body 102.

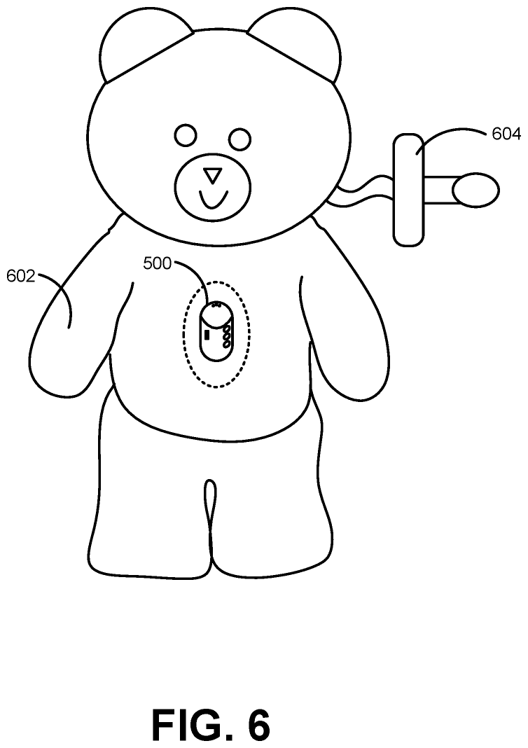

The soothing noise device 500 may allow a user to selectably dispose the device 500 in a stuffed toy. For example, as shown in the example embodiment depicted in FIG. 6, the device 500 may be disposed in an interior portion of the body of a stuffed toy 602. The stuffed toy 602 may include an opening that a user may selectably open and use to insert the device 500 into the stuffed toy 602. In some embodiments, the stuffed toy 602 may include a pacifier 604 disposed on the stuffed toy 602. The pacifier 604 may selectably couple to the stuffed toy 602.

The soothing noise device 500, in close proximity to an infant or young child using the stuffed toy, may sooth the infant or young child. The device 500 may be in close proximity to the infant's or young child's ears, but the sound emanating from the device 500 may not damage the infant's or young child's ears.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure. Furthermore, the components of the device 100, the assembly 400, or the device 500, are example components, and other components or configurations may be used.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “providing”, “sending”, “adjusting”, “determining”, “playing”, or the like, may refer to the actions and processes of a microprocessor, a computing device, or a similar electronic device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, one or more methodologies are described herein as a series of acts. However, acts in accordance with this disclosure can occur in various orders and/or concurrently, and with other acts not presented and described herein. Furthermore, not all described acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion. Use of the term “a” or “an” include “one or more” unless otherwise specified.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like may refer to a computer-related entity, either hardware (e.g., a circuit), firmware, software, a combination of hardware and software, or an entity related to an operational machine with one or more specific functionalities. For example, a component can be, but is not limited to being, a process running on a processing device, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A device, comprising:
a body couplable to a pacifier, wherein the body comprises a recess;
a circuit board disposed at least partially inside the recess;
a speaker connected to the circuit board; and
a sound emission aperture disposed over the speaker, wherein the sound emission aperture is adapted to allow sound from the speaker to be emitted through the sound emission aperture.

2. The device of claim 1, wherein the body further comprises:
a first side, wherein the first side is adapted to couple to the pacifier; and
a second side disposed opposite the first side, wherein the second side comprises the recess.

3. The device of claim 1, wherein the body further comprises a light indicator disposed on a surface of the body and connected to the circuit board.

4. The device of claim 1, wherein the body further comprises a port embedded in the body and connected to the circuit board.

5. The device of claim 4, wherein the port comprises:
a power charging port; and
a data connection port.

6. The device of claim 1, further comprising a battery disposed in the recess and connected to the circuit board.

7. The device of claim 1, further comprising a power button assembly in connection with the circuit board, wherein the power button assembly activates and deactivates the device.

8. The device of claim 1, further comprising a volume adjustment assembly that adjusts a volume of the speaker.

9. The device of claim 1, further comprising a sound adjustment assembly that changes a sound emitted from the speaker.

10. The device of claim 1, wherein the circuit board comprises:
a microcontroller comprising a central processing unit (CPU);
a memory storing a plurality of audio files; and
one or more input/output (I/O) interfaces.

11. The device of claim 1, wherein one or more components of the speaker limit a volume of the speaker to below a threshold volume.

12. The device of claim 1, wherein the circuit board limits a volume of the speaker below a threshold volume.

13. An assembly, comprising:
a pacifier, comprising an artificial nipple and a shield disposed on an end of the artificial nipple; and
a soothing noise device disposed on the shield, wherein the soothing noise device comprises:
a body disposed on the pacifier, wherein the body comprises a recess,
a circuit board disposed at least partially inside the recess,
a speaker connected to the circuit board, and
a sound emission aperture disposed over the speaker, wherein the sound emission aperture is adapted to allow sound from the speaker to be emitted through the sound emission aperture.

14. The assembly of claim 13, wherein the artificial nipple comprises a silicone.

15. The assembly of claim 13, wherein:
the shield comprises:
a first side facing the artificial nipple, and
a second side disposed opposite the first side; and
the body being disposed on the pacifier comprises the body being disposed on the second side of the shield.

16. The assembly of claim 13, wherein:
the circuit board comprises a wireless input/output (I/O) interface in wireless data communication with a mobile device; and
the wireless I/O interface is configured to receive wireless signals from the mobile device to perform one or more operations on the circuit board.

17. A device, comprising:
a body comprising an outer shell and an enclosure surrounded by the outer shell;
a circuit board disposed at least partially in the enclosure;
a speaker connected to the circuit board; and
a sound emission aperture disposed over the speaker, wherein the sound emission aperture is adapted to allow sound from the speaker to be emitted through the sound emission aperture.

18. The device of claim 17, wherein the body further comprises a light indicator disposed on a surface of the body and connected to the circuit board.

19. The device of claim 17, further comprising a sound adjustment assembly that changes a sound emitted from the speaker.

20. The device of claim 17, wherein the body is adapted for disposal in a stuffed toy.
